(19) United States
(12) Patent Application Publication
(10) Pub. No.: US 2003/0114299 A1
(43) Pub. Date: Jun. 19, 2003

(54) Desulfurization and novel sorbent for same

(76) Inventor: Gyanesh P. Khare, Kingwood, TX (US)

Correspondence Address: RICHMOND, HITCHCOCK, FISH & DOLLAR, P.O. Box 2443, Bartlesville, OK, 74005, US

(21) Appl. No.: 10/021,982

(22) Filed: Nov. 28, 2001

(51) Int. Cl. B01J 20/10; C10G 29/00

(52) U.S. Cl. 502/411; 502/407; 502/406; 208/244

(57) ABSTRACT

A sorbent composition comprising a support, a promoter, and a silicate can be used to desulfurize a hydrocarbon-containing fluid such as cracked-gasoline or diesel fuel.

### BACKGROUND OF THE INVENTION

This invention relates to a sorbent composition, a process of making a sorbent composition, and a process of using a sorbent composition for the removal of sulfur from a hydrocarbon-containing fluid.

Hydrocarbon-containing fluids such as gasoline and diesel fuels typically contain a quantity of sulfur. High levels of sulfur in such automotive fuels is undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as, automobile gasolines, racing gasolines, aviation gasolines, boat gasolines, and the like.

Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained.

In addition to the need for removing sulfur from cracked-gasoline, there is also a need to reduce the sulfur content in diesel fuel. In removing sulfur from diesel fuel by hydrodesulfurization, the cetane is improved but there is a large cost in hydrogen consumption. Such hydrogen is consumed by both hydrodesulfurization and aromatic hydrogenation reactions. Thus, there is a need for a process wherein desulfurization is achieved without a significant consumption of hydrogen so as to provide a more economical process for the desulfurization of hydrocarbon-containing fluids.

Traditionally, sorbent compositions used in processes for the removal of sulfur from hydrocarbon-containing fluids have been agglomerates utilized in fixed bed applications. Because fluidized bed reactors have advantages over fixed bed reactors such as better heat transfer and better pressure drop, hydrocarbon-containing fluids are sometimes processed in fluidized bed reactors. Fluidized bed reactors generally use sorbents that are in the form of relatively small particulates. The size of these particulates is generally in the range of from about 1 micrometer to about 1000 micrometers. However, conventional sorbents generally do not have sufficient attrition resistance (i.e., resistance to physical deterioration) for all applications. Consequently, finding a sorbent with sufficient attrition resistance that removes sulfur from these hydrocarbon-containing fluids and that can be used in fluidized, transport, moving, or fixed bed reactors is desirable and would be of significant contribution to the art and to the economy.

### SUMMARY OF THE INVENTION

It is thus an object of the present invention to provide a novel sorbent system for the removal of sulfur from hydrocarbon-containing fluid streams such as cracked-gasoline and diesel fuels.

Another object of the present invention is to provide a novel sorbent composition having an enhanced attrition resistance.

Yet another object of this invention is to provide a method of making a novel sorbent which is useful in the desulfurization of such hydrocarbon-containing fluid streams.

Still another object of this invention is to provide a process for the removal of sulfur-containing compounds from hydrocarbon-containing fluid streams which minimizes saturation of olefins and aromatics therein.

A further object of this invention is to provide a process for the removal of sulfur-containing compounds from hydrocarbon-containing fluid streams which minimizes hydrogen consumption.

It should be noted that the above-listed objects need not all be accomplished by the invention claimed herein and other objects and advantages of this invention will be apparent from the following description of the invention and appended claims.

In one aspect of the present invention, there is provided a novel sorbent composition suitable for removing sulfur from a hydrocarbon-containing fluid. The sorbent composition comprises a support, a promoter, and a silicate.

In accordance with another aspect of the present invention, there is provided a process of making a sorbent composition. The process comprises: admixing a first support component and a second support component to form a support mix; particulating the support mix to thereby provide a support particulate; contacting the support particulate with a promoter to thereby provide a promoted particulate comprising an unreduced promoter; reducing the promoted particulate to provide a reduced sorbent composition comprising a reduced-valence promoter; and incorporating a silicate with a silicate-enhanced component selected from the group consisting of the support mix, the support particulate, the promoted particulate, and combinations thereof.

In accordance with a further aspect of the present invention, there is provided a process for removing sulfur from a hydrocarbon-containing fluid stream. The process comprises the steps of: contacting the hydrocarbon-containing fluid stream with a sorbent composition comprising a support, a promoter, and a silicate in a desulfurization zone under conditions such that there is formed a desulfurized fluid stream and a sulfurized sorbent; separating the desulfurized fluid stream from the sulfurized sorbent; regenerating at least a portion of the separated sulfurized sorbent in a regeneration zone so as to remove at least a portion of the sulfur therefrom and provide a desulfurized sorbent; reducing the desulfurized sorbent in an activation zone to provide a reduced sorbent composition which will affect the removal of sulfur from the hydrocarbon-containing fluid stream when contacted with the same; and returning at least a portion of the reduced sorbent composition to the desulfurization zone.

### DETAILED DESCRIPTION OF THE INVENTION

In accordance with a first embodiment of the present invention, a novel sorbent composition suitable for removing sulfur from hydrocarbon-containing fluids is provided. The sorbent composition comprises a support, a promoter, and a silicate.

The support may be any component or combination of components which can be used as a support for the sorbent composition of the present invention to help promote the desulfurization process of the present invention. Preferably, the support is an active component of the sorbent composition. Examples of suitable support components include, but are not limited to, zinc oxide and any suitable inorganic and/or organic carriers. Examples of suitable inorganic carriers include, but are not limited to, silica, silica gel, alumina, diatomaceous earth, expanded perlite, kieselguhr, silica-alumina, titania, zirconia, zinc aluminate, zinc titanate, zinc silicate, magnesium aluminate, magnesium titanate, synthetic zeolites, natural zeolites, and combinations thereof. Examples of suitable organic carriers include, but are not limited to, activated carbon, coke, charcoal, carbon-containing molecular sieves, and combinations thereof. A preferred support comprises zinc oxide, silica, and alumina.

When the support comprises zinc oxide, the zinc oxide used in the preparation of the sorbent composition of the present invention can be either in a form of zinc oxide, such as powdered zinc oxide, or in the form of one or more zinc compounds that are convertible to zinc oxide under the conditions of preparation described herein. Examples of suitable zinc compounds include, but are not limited to, zinc sulfide, zinc sulfate, zinc hydroxide, zinc carbonate, zinc acetate, zinc nitrate, and combinations thereof. Preferably, the zinc oxide is in the form of powdered zinc oxide. When the support comprises zinc oxide, the zinc oxide will generally be present in the sorbent composition of the present invention in an amount in the range of from about 10 to about 90 weight percent zinc oxide based on the total weight of the sorbent composition, preferably in an amount in the range of from about 15 to about 60 weight percent zinc oxide, and most preferably in an amount in the range of from 20 to 55 weight percent zinc oxide.

When the support comprises silica, the silica used in the preparation of the sorbent composition of the present invention can be either in the form of silica or in the form of one or more silicon compounds. Any suitable type of silica may be employed in preparing the sorbent composition of the present invention. Examples of suitable types of silica include, but are not limited to, diatomite, expanded perlite, silicalite, silica colloid, flame-hydrolyzed silica, hydrolyzed silica, silica gel, precipitated silica, and combinations thereof. In addition, silicon compounds that are convertible to silica such as silicic acid, ammonium silicate and the like and combinations thereof can also be employed. Preferably, the silica is in the form of diatomite or expanded perlite. When the support comprises silica, the silica will generally be present in the sorbent composition of the present invention in an amount in the range of from about 5 to about 85 weight percent silica based on the total weight of the sorbent composition, preferably in an amount in the range of from about 10 to about 60 weight percent silica, and most preferably in an amount in the range of from about 15 to 55 weight percent silica.

When the support comprises alumina, the alumina used in preparing the sorbent composition of the present invention can be present in the source of silica, can be any suitable commercially available alumina material (including, but not limited to, colloidal alumina solutions, hydrated aluminas, and, generally, those alumina compounds produced by the dehydration of alumina hydrates), or both. The preferred alumina is a hydrated alumina such as, for example, boehmite or pseudoboehmite. When the support comprises alumina, the alumina will generally be present in the sorbent composition of the present invention in an amount in the range of from about 1 to about 30 weight percent alumina based on the total weight of the sorbent composition, preferably in an amount in the range of from about 5 to about 20 weight percent alumina, and most preferably in an amount in the range of from 5 to 15 weight percent alumina.

The promoter can be any component which can be added to the sorbent composition of the present invention to help promote the desulfurization process. The promoter is preferably a metal or metal oxide. As used herein, the term “metal” denotes metal in any form such as elemental metal or a metal-containing compound. As used herein, the term “metal oxide” denotes metal oxide in any form such as a metal oxide or a metal oxide precursor.

The metal or metal component of the metal oxide is preferably selected from the group consisting of nickel, cobalt, iron, manganese, copper, zinc, molybdenum, tungsten, silver, tin, vanadium, antimony, and combinations thereof. More preferably, the metal or metal component of the metal oxide is selected from the group consisting of nickel, cobalt, and combinations thereof. Most preferably, the promoter comprises nickel or nickel oxide. In a preferred method of making the present invention, the sorbent composition is promoted with a precursor of nickel oxide such as nickel nitrate, more preferably nickel nitrate hexahydrate.

A portion, preferably a substantial portion, of the promoter present in the final sorbent composition is present in a reduced-valence state. Such reduced-valence promoter preferably has a valence which is less than that of the promoter in its common oxidized state, more preferably less than 2, most preferably zero.

The promoter will generally be present in the sorbent composition of the present invention in an amount in the range of from about 1 to about 60 weight percent promoter based on the total weight of the sorbent composition, preferably in an amount in the range of from about 5 to about 50 weight percent promoter and, most preferably in an amount in the range of from 10 to 40 weight percent promoter.

Of the total quantity of the promoter present in the sorbent composition, it is preferred that at least 10 weight percent of the promoter is present as a reduced-valence promoter, more preferably at least 40 weight percent of the promoter is a reduced-valence promoter, and most preferably at least 80 weight percent of the promoter is a reduced-valence promoter.

The reduced-valence promoter will generally be present in the sorbent composition of the present invention in an amount in the range of from about 0.5 to about 50 weight percent reduced-valence promoter based on the total weight of the sorbent composition, preferably in an amount in the range of from about 4 to about 40 weight percent reduced-valence promoter, and most preferably in an amount in the range of from 4 to 35 weight percent reduced-valence promoter.

The silicate present in the composition of the present invention can be any silicate which can be added to a sorbent composition to enhance the attrition resistance of the sorbent composition. As used herein, the term “attrition resistance” is a measure of a particle's resistance to size reduction under controlled conditions of turbulent motion. The attrition resistance of a particle can be quantified using the Davison Index. The Davison Index represents the weight percent of the over 20 micrometer particle size fraction which is reduced to particle sizes of less than 20 micrometers under test conditions. The Davison Index is measured using a Jet cup attrition determination method. The Jet cup attrition determination method involves screening a 5 gram sample of sorbent to remove particles in the 0 to 20 micrometer size range. The particles above 20 micrometers are then subjected to a tangential jet of air at a rate of 21 liters per minute introduced through a 0.0625 inch orifice fixed at the bottom of a specially designed Jet cup (1″ I.D.×2″ height) for a period of 1 hour. The Davison Index (DI) is calculated as follows:

$$DI = \frac{Wt . of 0 \text{-} 20 Micrometer Formed During Test}{Wt . of Original + 20 Micrometer Fraction Being Tested} \times 100 \times Correction Factor$$

The correction factor (presently 0.3) is determined by using a known calibration standard to adjust for differences in Jet cup dimensions and wear.

The sorbent composition of the present invention preferably has a Davison Index of less than about 35 percent. More preferably, the sorbent composition of the present invention has a Davison Index of less than about 20 percent. Most preferably, the sorbent composition of the present invention has a Davison Index of less than 10 percent. A sorbent composition of the present invention, having a silicate incorporated therewith, has an enhanced attrition resistance when compared to sorbent compositions which do not include a silicate.

The silicate employed in the present invention can be any compound comprising silicon, oxygen, and one or more metals with or without hydrogen. The metal or metals of the silicate are preferably selected from the group consisting of sodium, potassium, zirconium, aluminum, barium, beryllium, calcium, iron, magnesium, manganese, and combinations thereof. Most preferably, the silicate is sodium silicate.

The silicate will generally be present in the sorbent composition of the present invention in an attrition-resistance-enhancing amount which is effective to enhance attrition resistance compared to a sorbent composition which does not have the silicate. The silicate will generally be present in the sorbent composition of the present invention in an amount in the range of from about 1 to about 40 weight percent silicate based on the total weight of the sorbent composition, preferably in an amount in the range of from about 5 to about 30 weight percent silicate, and more preferably in an amount in the range of from 10 to 20 weight percent silicate.

The sorbent composition of the present invention can additionally comprise a binder component. The binder can be any suitable compound that has cement-like properties which can help to bind the particulate composition together. Suitable examples of such binders include, but are not limited to, cements such as, for example, gypsum plaster, common lime, hydraulic lime, natural cements, portland cements, and high alumina cements, and the like and combinations thereof. A particularly preferred binder is calcium aluminate. When a binder is present, the amount of binder in the sorbent composition of the present invention is generally in the range of from about 0.1 weight percent binder to about 50 weight percent binder. Preferably, the amount of binder in a sorbent composition of the present invention is in the range of from about 1 weight percent to about 40 weight percent and, more preferably in the range of 5 weight percent to 30 weight percent.

In accordance with a second embodiment of the present invention, a process for making the inventive sorbent composition of the first embodiment of the present invention is provided.

In the manufacture of the sorbent composition of the present invention, the support is generally prepared by combining a first support component, such as zinc oxide, and second support component, such as a carrier, by any suitable method or manner which provides for the intimate mixing of such components to thereby provide a substantially homogeneous mixture comprising the support components, preferably a substantially homogeneous mixture comprising zinc oxide and a carrier, most preferably a homogeneous mixture comprising zinc oxide, silica, and alumina. Any suitable means for mixing the support component can be used to achieve the desired dispersion of the components. Examples of suitable means for mixing include, but are not limited to, mixing tumblers, stationary shells or troughs, Muller mixers, which are of the batch or continuous type, impact mixers, and the like. It is presently preferred to use a Muller mixer as the means for mixing the support components.

The support ingredients are admixed by any manner known in the art to provide a support mix which can be in the form selected from the group consisting of a wet mix, a dough, a paste, a slurry, and the like. Such resulting support mix can then be shaped to form a particulate(s) selected from the group consisting of a granulate, an extrudate, a tablet, a sphere, a pellet, a micro-sphere, and the like. For example, if the resulting support mixture is in the form of a wet mix, the wet mix can be densified, dried, calcined, and thereafter shaped, or particulated, through the granulation of the densified, dried, calcined mix to form granulates. Also for example, when the resulting support mix is in the form of either a dough state or paste state, such resulting mixture can then be shaped, preferably extruded, to form a particulate, preferably cylindrical extrudates having a diameter in the range of from about 1/32 inch to ½ inch and any suitable length, preferably a length in the range of from about ⅛ inch to about 1 inch. The resulting support particulates, preferably cylindrical extrudates, are then dried and calcined under conditions as disclosed herein.

More preferably, the support mix is in the form of a slurry and the particulation of such slurry is achieved by spray drying the slurry to form micro-spheres thereof having a mean particle size generally in the range of from about 1 micrometer to about 500 micrometers, preferably in the range of from about 10 micrometers to about 300 micrometers. Spray drying is known in the art and is discussed in Perry's Chemical Engineers' Handbook, Sixth Edition, published by McGraw-Hill, Inc., at pages 20-54 through 20-58. Additional information can be obtained from the Handbook of Industrial Drying, published by Marcel Dekker. Inc., at pages 243 through 293. As used herein, the term “mean particle size” refers to the size of the particulate material as determined by using a RO-TAP Testing Sieve Shaker, manufactured by W. S. Tyler Inc., of Mentor, Ohio, or other comparable sieves. The material to be measured is placed in the top of a nest of standard eight inch diameter stainless steel framed sieves with a pan on the bottom. The material undergoes sifting for a period of about 10 minutes; thereafter, the material retained on each sieve is weighed. The percent retained on each sieve is calculated by dividing the weight of the material retained on a particular sieve by the weight of the original sample. This information is used to compute the mean particle size.

When the particulation is achieved by preferably spray drying, a dispersant can be utilized and can be any suitable compound that helps to promote the spray drying ability of the resulting mixture which is preferably in the form of a slurry which preferably comprises zinc oxide, silica, and alumina. In particular, the dispersant is useful in preventing deposition, precipitation, settling, agglomerating, adhering and caking of solid particles in a fluid medium. Examples of suitable dispersants include, but are not limited to, condensed phosphates, sulfonated polymers, ammonium polyacrylate, sodium polyacrylate, ammonium polymethacrylate, poly(methyl methacrylate), polyacrylic acid (sodium salt), polyacrylamide, and the like and combinations thereof. The term “condensed phosphates” refers to any dehydrated phosphate where the H₂O:P₂O₅ is less than about 3:1. Specific examples of suitable dispersants include, but are not limited to, sodium pyrophosphate, sodium metaphosphate, sulfonated styrene maleic anhydride polymer, and the like and combinations thereof. The amount of the dispersant used is generally in the range of from about 0.01 weight percent to about 10 weight percent dispersant based on the total weight of the support. Preferably, the amount of the dispersant used is in the range of from about 0.1 weight percent to about 8 weight percent and, more preferably the amount of the dispersant used is in the range of from 1 weight percent to 5 weight percent.

In preparing a preferred spray-dried sorbent composition of the present invention, an acid can be used. In general, the acid can be an organic acid or a mineral acid. If the acid is an organic acid, it is preferably a carboxylic acid. If the acid is a mineral acid it is preferably a nitric acid, a phosphoric acid, hydrochloric acid, or a sulfuric acid. Mixtures of these acids can also be used. Generally, the acid is used with water to form a dilute aqueous acid solution. The amount of acid in the aqueous acid solution is generally in the range of from about 0.01 volume percent to about 20 volume percent based on the total volume of the acid solution. Preferably, the amount of acid is in the range of from about 0.1 volume percent to about 15 volume percent, and more preferably the amount of acid is in the range of from 1 volume percent to 10 volume percent. In general, the amount of acid to be used is based on the amount of the dry components. That is, the ratio of all of the dry components (in grams) to the acid (in milliliters) should be less than about 1.75:1. However, it is preferred if this ratio is less than about 1.25:1 and it is more preferred if it is less than about 0.75:1. These ratios will help to form a mixture that is a liquid solution, a slurry, or a paste that is capable of being dispersed in a fluid-like spray.

The spray-dried support particulate can then be dried and calcined under drying and calcining conditions disclosed herein, to form a dried and calcined support particulate.

The resulting dried and calcined support particulate is then contacted with the promoter to thereby incorporate the promoter with the dried and calcined support particulate. The promoter may be incorporated in, on, or with the dried and calcined support particulate by any suitable means or method known in the art such as, for example, impregnating, soaking, spraying, and combinations thereof. The preferred method of incorporating the promoter into the dried and calcined support particulate is impregnating using standard incipient wetness impregnation techniques. A preferred method uses an impregnating solution comprising the desired concentration of the promoter so as to ultimately provide a promoted particulate which can be subjected to drying, calcining, and reduction to provide the sorbent composition of the present invention. The impregnating solution can be any aqueous solution in amounts of such solution which suitably provides for the impregnation of the dried and calcined support particulates. A preferred impregnating solution is formed by dissolving a promoter-containing compound in water. It is acceptable to use somewhat of an acidic solution to aid in the dissolution of the promoter-containing compound. It is more preferred for the support particulates to be impregnated with the promoter by use of a solution containing nickel nitrate hexahydrate dissolved in water.

Generally, the amount of the promoter incorporated, preferably impregnated, onto, into, or with the support component is an amount which provides, after the promoted particulate material has been dried calcined, and reduced, a sorbent composition having an amount of the promoter as disclosed herein. It may be necessary to employ more than one incorporation step in order to obtain the desired quantity of promoter. If so, such additional incorporation(s) are performed in the same manner described above.

Once the promoter has been incorporated in, on, or with the dried and calcined support particulate, the promoted particulate is subsequently dried and calcined under conditions disclose herein to thereby provide a dried, calcined, promoted particulate comprising an unreduced promoter.

Generally, a drying condition, as referred to herein, can include a temperature in the range of from about 180° F. to about 290° F., preferably in the range of from about 190° F. to about 280° F., and more preferably in the range of from 200° F. to 270° F. Such drying condition can also include a time period generally in the range of from about 0.5 hour to about 60 hours, preferably in the range of from about 1 hour to about 40 hours, and more preferably in the range of from 1.5 hours to 20 hours. Such drying condition can also include a pressure generally in the range of from about atmospheric (i.e., about 14.7 pounds per square inch absolute) to about 150 pounds per square inch absolute (psia), preferably in the range of from about atmospheric to about 100 psia, more preferably about atmospheric, so long as the desired temperature can be maintained. Any drying method(s) known to one skilled in the art such as, for example, air drying, heat drying, vacuum drying, and the like and combinations thereof can be used.

Generally, a calcining condition, as referred to herein, can include a temperature in the range of from about 400° F. to about 1800° F., preferably in the range of from about 600° F. to about 1600° F., and more preferably in the range of from 800° F. to about 1500° F. Such calcining condition can also include a time period generally in the range of from about 1 hour to about 60 hours, preferably in the range of from about 2 hours to about 20 hours, and more preferably in the range of from 3 hours to 15 hours. Such calcining condition can also include a pressure, generally in the range of from about 7 pounds per square inch absolute (psia) to about 750 psia, preferably in the range of from about 7 psia to about 450 psia, and more preferably in the range of from 7 psia to 150 psia.

The dried, calcined, promoted particulates are thereafter subjected to reduction with a suitable reducing agent, preferably hydrogen, under reducing conditions, to thereby provide a reduced sorbent composition comprising a reduced-valence promoter having a valence which is less than that of the unreduced promoter, preferably less than 2, most preferably zero. Reduction can be carried out at a temperature in the range of from about 100° F. to about 1500° F. and at a pressure in the range of from about 15 pounds per square inch absolute (psia) to about 1,500 psia. Such reduction is carried out for a time period sufficient to achieve the desired level of reduction of the promoter. Such reduction can generally be achieved in a time period in the range of from about 0.01 hour to about 20 hours.

The silicate can be incorporated into the sorbent composition at a variety of stages during the above-described preparation of the sorbent composition and in a variety of manners. For example, the silicate can be incorporated onto, into, or with the support mix, the unpromoted support particulate (before or after drying and calcining), the promoted particulate (before or after drying and calcining), or combinations thereof.

If the silicate is incorporated into the support mix, such incorporation is preferably accomplished by physically mixing the silicate with the support mix using any means known in art. Such mixing can be accomplished in the same manner in which the components of the support mix were combined. When the silicate is incorporated into the support mix preferably, zinc oxide, alumina, silica, and the silicate are mixed together to provide a support slurry capable of particulation by spray drying.

If the silicate is incorporated onto, into or with a particulate such as the unpromoted support particulate (before or after drying and calcining) or the promoted particulate (before or after drying and calcining), such incorporation can be accomplished by any method known in the art. It is presently preferred that the silicate incorporation always be followed by at least one promoter incorporation prior to reduction. Suitable methods of contacting the particulate with the silicate can include, but are not limited to, impregnating techniques such as standard incipient wetness impregnation (i.e., essentially completely filling the pores of a substrate material with a solution of the incorporating elements), spray impregnation techniques, wet impregnation, spray drying, chemical vapor deposition, plasma spray deposition, melting impregnation, and the like. It is preferred, however, to use a spray impregnation technique whereby the particulate is contacted with a fine spray of a solution containing the silicate wherein the solution has the desired amount of the silicate dissolved in a sufficient volume of an aqueous medium, such as water, to fill the total pore volume of the particulate or, in other words, to effect an incipient wetness impregnation of the particulate. For example, spraying of an aqueous solution containing silicate onto the sorbent material can be conducted using a ultrasonic nozzle to atomize the aqueous solution which can then be sprayed onto the particulate while such particulate is rotated on a disk or being tumbled in a tumbler.

The concentration of the silicate in the aqueous solution can generally be in the range of from about 0.1 gram of silicate per gram of solution to about 10 grams of silicate per gram of solution. Preferably, the concentration of the silicate in the solution can be in the range of from about 0.1 gram of silicate per gram of solution to about 5 grams of silicate per gram of solution and, more preferably, the concentration of silicate in the solution can be in the range of from 0.1 gram of silicate per gram of solution to 2 grams of silicate per gram of solution. Generally, the weight ratio of silicate to solution can be in the range of from about 0.25:1 to about 2:1, preferably, in the range of from about 0.5:1 to about 1.5:1 and, more preferably, in the range of from 0.75:1 to 1.25:1.

After incorporation of the silicate on, in, or with the particulate, the attrition-resistance-enhanced particulate is preferably dried and calcined under drying and calcining conditions disclosed herein.

In accordance with a third embodiment of the present invention, a desulfurization process is provided which employs the novel sorbent composition described herein.

The hydrocarbon-containing fluid feed employed in the desulfurization process of this embodiment of the present invention is preferably a sulfur-containing hydrocarbon fluid, more preferably, gasoline or diesel fuel, most preferably cracked-gasoline or diesel fuel.

The hydrocarbon-containing fluid described herein as suitable feed in the process of the present invention comprises a quantity of olefins, aromatics, sulfur, as well as paraffins and naphthenes. The amount of olefins in gaseous cracked-gasoline is generally in the range of from about 10 to about 35 weight percent olefins based on the total weight of the gaseous cracked-gasoline. For diesel fuel there is essentially no olefin content. The amount of aromatics in gaseous cracked-gasoline is generally in the range of from about 20 to about 40 weight percent aromatics based on the total weight of the gaseous cracked-gasoline. The amount of aromatics in gaseous diesel fuel is generally in the range of from about 10 to about 90 weight percent aromatics based on the total weight of the gaseous diesel fuel. The amount of sulfur in the hydrocarbon-containing fluid, preferably cracked-gasoline or diesel fuel, suitable for use in a process of the present invention can be in the range of from about 100 parts per million sulfur by weight of the cracked-gasoline to about 10,000 parts per million sulfur by weight of the cracked-gasoline and from about 100 parts per million sulfur by weight of the diesel fuel to about 50,000 parts per million sulfur by weight of the diesel fuel prior to the treatment of such hydrocarbon-containing fluid with the process of the present invention. The amount of sulfur in the desulfurized hydrocarbon-containing fluid following treatment in accordance with the process of the present invention is less than about 100 parts per million (ppm) sulfur by weight of hydrocarbon-containing fluid, preferably less than about 90 ppm sulfur by weight of hydrocarbon-containing fluid, and more preferably less than about 80 ppm sulfur by weight of hydrocarbon-containing fluid.

As used herein, the term “gasoline” denotes a mixture of hydrocarbons boiling in the range of from about 100° F. to about 400° F., or any fraction thereof. Examples of suitable gasoline include, but are not limited to, hydrocarbon streams in refineries such as naphtha, straight-run naphtha, coker naphtha, catalytic gasoline, visbreaker naphtha, alkylate, isomerate, reformate, and the like and combinations thereof.

As used herein, the term “cracked-gasoline” denotes a mixture of hydrocarbons boiling in the range of from about 100° F. to about 400° F., or any fraction thereof, that are products from either thermal or catalytic processes that crack larger hydrocarbon molecules into smaller molecules. Examples of suitable thermal processes include, but are not limited to, coking, thermal cracking, visbreaking and the like and combinations thereof. Examples of suitable catalytic cracking processes include, but are not limited to fluid catalytic cracking, heavy oil cracking, and the like and combinations thereof. Thus, examples of suitable cracked-gasoline include, but are not limited to, coker gasoline, thermally cracked gasoline, visbreaker gasoline, fluid catalytically cracked gasoline, heavy oil cracked gasoline, and the like and combinations thereof. In some instances, the cracked-gasoline may be fractionated and/or hydrotreated prior to desulfurization when used as a hydrocarbon-containing fluid in a process of the present invention.

As used herein, the term “diesel fuel” denotes a mixture of hydrocarbons boiling in the range of from about 300° F. to about 750° F., or any fraction thereof. Examples of suitable diesel fuels include, but are not limited to, light cycle oil, kerosene, jet fuel, straight-run diesel, hydrotreated diesel, and the like and combinations thereof.

As used herein, the term “sulfur” denotes sulfur in any form such as elemental sulfur or a sulfur compound normally present in a hydrocarbon-containing fluid such as cracked gasoline or diesel fuel. Examples of sulfur which can be present during a process of the present invention, usually contained in a hydrocarbon-containing fluid, include, but are not limited to, hydrogen sulfide, carbonyl sulfide (COS), carbon disulfide (CS₂), mercaptans (RSH), organic sulfides (R—S—R), organic disulfides (R—S—S—R), thiophene, substituted thiophenes, organic trisulfides, organic tetrasulfides, benzothiophene, alkyl thiophenes, alkyl benzothiophenes, alkyl dibenzothiophenes, and the like and combinations thereof as well as the heavier molecular weights of same which are normally present in a diesel fuel of the types contemplated for use in a process of the present invention, wherein each R can be an alkyl or cycloalkyl or aryl group containing one carbon atom to ten carbon atoms.

As used herein, the term “fluid” denotes gas, liquid, vapor, and combinations thereof.

As used herein, the term “gaseous” denotes that state in which the hydrocarbon-containing fluid, such as cracked-gasoline or diesel fuel, is primarily in a gas or vapor phase.

The desulfurizing of the hydrocarbon-containing fluid is carried out in a desulfurization zone under a set of conditions that includes total pressure, temperature, weight hourly space velocity, and hydrogen flow. These conditions are such that the sorbent composition can desulfurize the hydrocarbon-containing fluid to produce a desulfurized hydrocarbon-containing fluid and a sulfurized sorbent composition.

In desulfurizing the hydrocarbon-containing fluid, it is preferred that the hydrocarbon-containing fluid, preferably cracked-gasoline or diesel fuel, be in a gas or vapor phase. However, in the practice of the present invention it is not essential that the hydrocarbon-containing fluid be totally in a gas or vapor phase.

In desulfurizing the hydrocarbon-containing fluid, the total pressure can be in the range of from about 15 pounds per square inch absolute (psia) to about 1500 psia. However, it is presently preferred that the total pressure be in a range of from about 50 psia to about 500 psia. In general, the temperature should be sufficient to keep the hydrocarbon-containing fluid in essentially a vapor or gas phase. While such temperatures can be in the range of from about 100° F. to about 1000° F., it is presently preferred that the temperature be in the range of from about 400° F. to about 800° F. when treating a cracked-gasoline and in the range of from about 500° F. to about 900° F. when treating a diesel fuel.

Weight hourly space velocity (WHSV) is defined as the numerical ratio of the rate at which a hydrocarbon-containing fluid is charged to the desulfurization zone in pounds per hour at standard condition of temperature and pressure (STP) divided by the pounds of sorbent composition contained in the desulfurization zone to which the hydrocarbon-containing fluid is charged. In the practice of the present invention, such WHSV should be in the range of from about 0.5 hr⁻¹ to about 50 hr⁻¹, preferably in the range of from about 1 hr⁻¹ to about 20 hr⁻¹. The desulfurizing (i.e., desulfurization) of the hydrocarbon-containing fluid should be conducted for a time sufficient to affect the removal of at least a substantial portion sulfur from such hydrocarbon-containing fluid.

In desulfurizing the hydrocarbon-containing fluid, it is presently preferred that an agent be employed which interferes with any possible chemical or physical reacting of the olefinic and aromatic compounds in the hydrocarbon-containing fluid which is being treated with a sorbent composition of the present invention. Preferably, such agent is hydrogen. Hydrogen flow in the desulfurization zone is generally such that the mole ratio of hydrogen to hydrocarbon-containing fluid is the range of from about 0.1 to about 10, preferably in the range of from about 0.2 to about 3.

If desired, during the desulfurizing of the hydrocarbon-containing fluid according to the process of the present invention, a diluent such as methane, carbon dioxide, flue gas, nitrogen and the like and combinations thereof can be used. Thus, it is not essential to the practice of a process of the present invention that a high purity hydrogen be employed in achieving the desired desulfurization of a hydrocarbon-containing fluid such as cracked-gasoline or diesel fuel.

It is presently preferred, when the desulfurization zone is in a fluidized bed reactor system, that a sorbent composition be used having a mean particle size, as described herein, in the range of from about 1 micrometer to about 500 micrometers. Preferably, such sorbent composition has a mean particle size in the range of from about 10 micrometers to about 300 micrometers, most preferably, from about 10 to about 100 micrometers. When a fixed bed reactor system is employed as the desulfurization zone of the present invention, the sorbent composition should generally have a particulate size in the range of from about 1/32 inch to about ½ inch diameter, preferably in the range of from about 1/32 inch to about ¼ inch diameter. It is further presently preferred to use a sorbent composition having a surface area in the range of from about 1 square meter per gram to about 1000 square meters per gram (m²/g), preferably in the range of from about 1 m²/g to about 800 m²/g.

After sulfur removal in the desulfurization zone, the desulfurized hydrocarbon-containing fluid and sulfurized sorbent composition can then be separated by any manner or method known in the art that can separate a solid from a fluid, preferably a solid from a gas. Examples of suitable separating means for separating solids and gases include, but are not limited to, cyclonic devices, settling chambers, impingement devices, filters, and combinations thereof. The desulfurized hydrocarbon-containing fluid, preferably desulfurized gaseous cracked-gasoline or desulfurized gaseous diesel fuel, can then be recovered and preferably liquefied. Liquification of such desulfurized hydrocarbon-containing fluid can be accomplished by any manner or method known in the art.

The sulfurized sorbent is then regenerated in a regeneration zone under a set of conditions that includes temperature, total pressure, and sulfur removing agent partial pressure. The regenerating is carried out at a temperature generally in the range of from about 100° F. to about 1500° F., preferably in the range of from about 800° F. to about 1200° F. Total pressure is generally in the range of from about 25 pounds per square inch absolute (psia) to about 500 psia. The sulfur removing agent partial pressure is generally in the range of from about 1 percent to about 100 percent of the total pressure.

The sulfur removing agent, i.e., regenerating agent, is a composition(s) that helps to generate gaseous sulfur-containing compounds and oxygen-containing compounds such as sulfur dioxide, as well as to burn off any remaining hydrocarbon deposits that might be present. The preferred sulfur removing agent, i.e., regenerating agent, suitable for use in the regeneration zone is oxygen or an oxygen-containing gas(es) such as air. Such regeneration is carried out for a time sufficient to achieve the desired level of regeneration. Such regeneration can generally be achieved in a time period in the range of from about 0.1 hour to about 24 hours, preferably in the range of from about 0.5 hour to about 3 hours.

In carrying out the process of the present invention, a stripper zone can be inserted before and/or after, preferably before, regenerating the sulfurized sorbent composition in the regeneration zone. Such stripper zone, preferably utilizing a stripping agent, will serve to remove a portion, preferably all, of any hydrocarbon(s) from the sulfurized sorbent composition. Such stripper zone can also serve to remove oxygen and sulfur dioxide from the system prior to introduction of the regenerated sorbent composition into the activation zone. Such stripping employs a set of conditions that includes total pressure, temperature, and stripping agent partial pressure.

Preferably, the stripping, when employed, is carried out at a total pressure in the range of from about 25 pounds per square inch absolute (psia) to about 500 psia. The temperature for such stripping can be in the range of from about 100° F. to about 1000 F. Such stripping is carried out for a time sufficient to achieve the desired level of stripping. Such stripping can generally be achieved in a time period in the range of from about 0.1 hour to about 4 hours, preferably in the range of from about 0.3 hour to about 1 hour. The stripping agent is a composition(s) that helps to remove a hydrocarbon(s) from the sulfurized sorbent composition. Preferably, the stripping agent is nitrogen.

After regeneration, and optionally stripping, the desulfurized sorbent composition is then subjected to reducing, i.e., activating, in an activation zone with a reducing agent, preferably hydrogen, so that at least a portion of the unreduced promoter incorporated on, in, or with the sorbent composition is reduced to thereby provide a reduced sorbent composition comprising a reduced-valence promoter. Such reduced-valence promoter is incorporated on, in, or with such sorbent composition in an amount that provides for the removal of sulfur from the hydrocarbon-containing fluid according to a process of the present invention.

In general, when practicing a process of the present invention, the reducing, i.e., activating, of the desulfurized sorbent composition is carried out at a temperature in the range of from about 100° F. to about 1500° F. and at a pressure in the range of from about 15 pounds per square inch absolute (psia) to about 1500 psia. Such reduction is carried out for a time sufficient to achieve the desired level of promoter reduction. Such reduction can generally be achieved in a time period in the range of from about 0.01 hour to about 20 hours.

Following the reducing, i.e., activating, of the regenerated, desulfurized sorbent composition, at least a portion of the resulting reduced (i.e., activated) sorbent composition can be returned to the desulfurization zone.

When carrying out the desulfurization process of the present invention, the steps of desulfurizing, regenerating, reducing (i.e., activating), and optionally stripping before and/or after such regenerating, can be accomplished in a single zone or vessel or in multiple zones or vessels. The desulfurization zone can be any zone wherein desulfurizing a hydrocarbon-containing fluid such as cracked-gasoline, diesel fuel or the like can take place. The regeneration zone can be any zone wherein regenerating or desulfurizing a sulfurized sorbent composition can take place. The activation zone can be any zone wherein reducing, i.e., activating, a regenerated, desulfurized sorbent composition can take place. Examples of suitable zones are fixed bed reactors, moving bed reactors, fluidized bed reactors, transport reactors, reactor vessels and the like.

When carrying out the process of the present invention in a fixed bed reactor system, the steps of desulfurizing, regenerating, reducing, and optionally stripping before and/or after such regenerating are accomplished in a single zone or vessel. When carrying out the process of the present invention in a fluidized bed reactor system, the steps of desulfurizing, regenerating, reducing, and optionally stripping before and/or after such regenerating are accomplished in multiple zones or vessels.

When the desulfurized hydrocarbon-containing fluid resulting from the practice of a process of the present invention is a desulfurized cracked-gasoline, such desulfurized cracked-gasoline can be used in the formulation of gasoline blends to provide gasoline products suitable for commercial consumption and can also be used where a cracked-gasoline containing low levels of sulfur is desired.

When the desulfurized hydrocarbon-containing fluid resulting from the practice of a process of the present invention is a desulfurized diesel fuel, such desulfurized diesel fuel can be used in the formulation of diesel fuel blends to provide diesel fuel products suitable for commercial consumption and can also be used where a diesel fuel containing low levels of sulfur is desired.

The following examples are presented to further illustrate this invention and are not to be construed as unduly limiting the scope of this invention. Mesh sieve numbers used in the Examples are U.S. Standard Sieve Series, ASTM Specification E-11-61.

### EXAMPLE I

Sorbent A (control) was prepared by mixing 20 grams of sodium pyrophosphate (available from Aldrich Chemical Company, Milwaukee, Wis.) and 2224 grams of distilled water in a Cowles dissolver to create a sodium pyrophosphate solution. A 200 gram quantity of aluminum hydroxide powder (Dispal® Alumina Powder, available from CONDEA Vista Company, Houston, Tex.), a 628 gram quantity of diatomaceous earth (Celite® Filter Cell, available from Manville Sales Corporation, Lampoc, Calif.), and a 788 gram quantity of zinc oxide powder (available from Zinc Corporation, Monaca, Pa.) were then mixed to form a powdered mixture. The powdered mixture was slowly added to the sodium pyrophosphate solution and mixed for 15 minutes to create a sorbent base slurry. The resulting mixed slurry was sieved through a 25-mesh screen.

The sorbent base slurry was then formed into sorbent base particulate using a counter-current spray drier (Niro Mobile Minor Spray Dryer, available from Niro Inc., Columbia, Md.). The sorbent base slurry was charged to the spray drier wherein it was contacted in a particulating chamber with air flowing through the chamber. The operating conditions of the spray dryer included an inlet temperature of 320° C. and an outlet temperature of about 100° C. to about 120° C. The sorbent base particulate was then dried in an oven by ramping the oven temperature at 3° C./min to 150° C. and holding at 150° C. for 3 hours. The dried sorbent base particulate was then calcined by ramping the oven temperature at 3° C./min to 635° C. and holding at 635° C. for 1 hour.

The calcined sorbent base particulate was then sieved to provide a 100 gram quantity which passed through the 50 mesh sieve but was retained above the 140 mesh sieve (i.e., −50/+140 mesh). The resulting 100 gram quantity of sieved sorbent base particulate was then impregnated with a solution containing 59.42 grams of nickel nitrate hexahydrate and 62.9 grams of distilled water using incipient wetness techniques. The impregnated sorbent was then put in an oven and dried by ramping the oven temperature at 3° C./min to 150° C. and holding at 150° C. for 3 hours. The dried sorbent was then calcined by ramping the oven temperature at 3° C./min to 635° C. and holding at 635° C. for 1 hour. The resulting nickel-promoted sorbent was designated Sorbent A.

Sorbent B (control) was prepared by impregnating a 50.0 gram quantity of Sorbent A with a solution containing 37.14 grams of nickel nitrate hexahydrate and 7.45 grams of distilled water by spraying the solution on the sorbent with an ultrasonic nozzle. The twice-impregnated sorbent was then put in an oven and dried by ramping the oven temperature at 3° C./min to 150° C. and holding at 150° C. for 1 hour. The dried sorbent was then calcined by ramping the over temperature at 5° C./min to 635° C. and holding at 635° C. for 1 hour. The resulting twice-nickel-promoted sorbent was designated Sorbent B.

Sorbent C was prepared by mixing 20 grams of sodium pyrophosphate (available from Aldrich Chemical Company, Milwaukee, Wis.), 1690 grams of dionized water, 200 grams of aluminum hydroxide powder (Dispal® Alumina Powder, available from CONDEA Vista Company, Houston, Tex.), 471 grams of diatomaceous earth (Celite® Filter Cell, available from Manville Sales Corporation, Lampoc, Calif.), 788 grams of zinc oxide powder (available from Zinc Corporation, Monaca, Pa.), and 870 grams of a sodium silicate solution containing 9.1% Na₂O and 29.2% SiO₂ (available from Brainerd Chemical Co., Tulsa, Okla.) to form a sorbent base slurry.

The sorbent base slurry was then formed into sorbent base particulate using a counter-current spray drier (Niro Mobile Minor Spray Dryer, available from Niro Inc., Columbia, Md.). The sorbent base slurry was contacted in a particulating chamber with air flowing through the chamber. The air flowing through the particulating chamber had an inlet temperature of about 320° C. and an outlet temperature of about 145° C. The sorbent base particulate was then dried in an oven by ramping the oven temperature at 3° C./min to 150° C. and holding at 150° C. for 1 hour. The dried sorbent base particulate was then calcined by ramping the oven temperature at 5° C./min to 635° C. and holding at 635° C. for 1 hour.

A 100 gram quantity of the calcined sorbent base particulate was then impregnated with a solution containing 74.28 grams of nickel nitrate hexahydrate and 8 grams of distilled water by spraying the solution on the particulate with an ultrasonic nozzle. The impregnated sorbent was then put in an oven and dried by ramping the oven temperature at 3° C./min to 635° C. and holding at 635° C. for 1 hour.

The dried sorbent was then calcined by ramping the oven temperature at 3° C./min to 635° C. and holding at 635° C. for 1 hour.

The nickel-promoted sorbent was then sieved and 114.6 grams of the sorbent which passed through the 50 mesh sieve and was retained above the 325 mesh sieve was retained. The 114.6 gram quantity of the −50/+325 nickel-promoted sorbent was then impregnated with a solution containing 85.12 grams of nickel nitrate hexahydrate and 8 grams of distilled water by spraying the solution on the sorbent with an ultrasonic nozzle. The twice-impregnated sorbent was then placed in an oven and dried by ramping the oven temperature at 3° C./min to 150° C. and holding at 150° C. for 1 hour. The dried sorbent was then calcined by ramping the oven temperature at 3° C./min to 635° C. and holding at 635° C. for 1 hour. The resulting nickel-promoted sorbent was designated Sorbent C.

Sorbent D was prepared by mixing 20.0 grams of sodium pyrophosphate (available from Aldrich Chemical Company, Milwaukee, Wis.), 1690 grams of deionized water, 200.0 grams of aluminum hydroxide powder (Dispal® Alumina Powder, CONDEA Vista Company, Houston, Tex.), 471 grams of diatomaceous earth (Celite® Filter Cell, available from Manville Sales Corporation, Lampoc, Calif.), 788 grams of zinc oxide powder (available from Zinc Corporation, Monaca, Pa.), and 870 grams of sodium silicate solution containing 9.1% Na₂O and 29.2% SiO₂ (available from Brainerd Chemical Company, Tulsa, Okla.) to form a sorbent base slurry.

The sorbent base slurry was then formed into particulate using a counter-current spray drier (available from Niro Inc., Columbia, Md.). The sorbent base slurry was contacted in a particulating chamber with air flowing through the chamber. The air flowing through the particulating chamber had an inlet temperature of about 320° C. and an outlet temperature of about 145° C. The sorbent base particulate was then placed in an oven and dried by ramping the oven temperature at 3° C./min to 150° C. and holding at 150° C. for 1 hour. The dried sorbent base particulate was then calcined by ramping the oven temperature at 5° C./min to 635° C. and holding at 635° C. for 1 hour.

A 100 gram quantity of the sorbent base particulate was then contacted with sodium silicate by heating the particulate to 300° F. and contacting it with a solution containing 40 ml of sodium silicate (9.1% Na₂O, 29.2% SiO₂, available from Brainerd Chemical Company, Tulsa, Okla.) and 10 ml of distilled water by spraying the solution on the particulate with an ultrasonic nozzle. The coated sorbent base particulate was then placed in an oven and dried by ramping the oven temperature at 5° C./min to 120° C. and holding at 120° C. for 2 hours. The dried, coated particulate was then calcined by ramping the oven temperature at 5° C./min to 538° C. and holding at 538° C. for 1 hour.

The calcined, coated sorbent base particulate was then sieved to obtain a 100 gram quantity of coated sorbent base particulate which passed through the 100 mesh sieve but was retained above the 325 mesh sieve.

The 100 gram quantity of −100/+325 mesh particulate was then impregnated with a solution containing 74.28 grams of nickel nitrate hexahydrate and 7 grams of distilled water by spraying the solution on the particulate with an ultrasonic nozzle. The impregnated sorbent was then placed in an oven and dried by ramping the oven temperature at 3° C./min to 150° C. and holding at 150° C. for 1 hour. The dried sorbent was then calcined by ramping the oven temperature at 5° C./min to 635° C. and holding at 635° C. for 1 hour. The resulting sorbent was designated Sorbent D.

Sorbent E was prepared by impregnating 50 grams of Sorbent D with a solution containing 37.14 grams of nickel nitrate hexahydrate and 4 grams of distilled water by spraying the solution on the sorbent with an ultrasonic nozzle. The twice-impregnated sorbent was then placed in an oven and dried by ramping the oven temperature at 3° C./min to 150° C. and holding at 150° C. for 1 hour. The dried sorbent was then calcined by ramping the oven temperature at 3° C./min to 635° C. and holding at 635° C. for 1 hour the resulting sorbent was designated Sorbent E.

### EXAMPLE II

The attrition resistance of Sorbents A-E was then determined using the Davison Test. The Davison Index, which represents the weight percent of the over 20 micrometer particle size fraction which is reduced to particle sizes of less than 20 micrometers under test conditions, was measured using a Jet cup attrition determination method. The Jet cup attrition determination involved screening a 5 gram sample of sorbent to remove particles in the 0 to 20 micrometer size range. The sorbent particles above 20 micrometers were then subjected to a tangential jet of air at a rate of 21 liters per minute introduced through a 0.0625 orifice fixed at the bottom of a specially designed Jet cup (1″ I.D.×2″ height) for a period of 1 hour. The Davison Index (DI) was calculated as follows:

$$DI = \frac{Wt . of 0 \text{-} 20 Micrometer Formed During Test}{Wt . of Original + 20 Micrometer Fraction Being Tested} \times 100 \times Correction Factor$$

The correction factor of 0.3 was determined using a known calibration standard to adjust for differences in Jet cup dimensions and wear.

Table 1 summarizes the results of the Davison Tests on Sorbents A-E.

TABLE 1
ATTRITION RESISTANCE TEST

| Sorbent | Davison Index (%) |
|---|---|
| A (Control- 15% Ni Impregnated) | 26.3 |
| B (Control- 30% Ni Impregnated) | 19.3 |
| C (Na₂SiO₃- Mixed + 15% Ni Impregnated) | 19.9 |
| D (Na₂SiO₃- Mixed and Sprayed + | 4.8 |
| 15% Ni Impregnated) | |
| E (Na₂SiO₃- Mixed and Sprayed + | 3.1 |
| 30% Ni Impregnated) | |

The results in Table 1 demonstrate that the presence of sodium silicate in and/or on a nickel-promoted sorbent enhances the attrition resistance of the sorbent.

### EXAMPLE III

Sorbents C-E were then reactor tested under desulfurization conditions.

A 10 gram quantity of −100/+325 mesh Sorbent C was placed in a reactor (1 inch I.D. fluidized bed reactor with clam shell heater) and heated to 700° F. Catalytically Cracked Gasoline (CCG) (345 ppmw sulfur), nitrogen, and hydrogen were then simultaneously charged to the reactor at 13.4 ml/hr, 150 cc/min, and 150 cc/min, respectively. The reactor bed temperature was maintained between about 730° F. and 740° F. Effluent samples were taken at 4 hourly increments and designated Samples 1A-4A.

CCG flow to the reactor was then terminated and the sulfurized sorbent was regenerated with air (60 cc/min) and nitrogen (240 cc/min) at a temperature of about 900° F. for about 100 minutes. The reactor temperature was then reduced to about 700° F. and the regenerated sorbent was reduced with hydrogen (300 cc/min) for about 95 minutes. CCG (345 ppmw sulfur), nitrogen, and hydrogen were then simultaneously charged to the reactor at 13.4 ml/hr, 150 cc/min, and 150 cc/min, respectively. The reactor bed temperature was maintained between about 730° F. and about 745° C. Effluent samples were taken at 4 hourly increments and designated Samples 1B-4B.

Samples 1A-4A (Cycle A) and 1B-4B (Cycle B) were analyzed for sulfur content using x-ray fluorescence. The results are summarized in Table 2.

TABLE 2
Desulfurization of CCG (345 ppmw Sulfur) with Sorbent C

| Sample | Cycle A (ppmw Sulfur) | Cycle B (ppmw Sulfur) |
|---|---|---|
| 1 | 220 | 5 |
| 2 | 60 | 10 |
| 3 | 10 | 10 |
| 4 | 10 | 15 |

A 10 gram quantity of −100/+325 mesh Sorbent D was placed in the reactor and heated to 700° F. CCG (345 ppmw sulfur) was then desulfurized in the reactor in substantially the same manner and under substantially the same conditions as described with respect to Sorbent C. Effluent Samples were taken at 4 hourly increments and designated samples 1A-4A (Cycle A).

The sulfurized sorbent was then regenerated and reduced in substantially the same manner as described with respect to Sorbent C. CCG was then desulfurized as described in Cycle A. Effluent samples were taken at hourly increments and designated 1B-4B (Cycle B).

The sulfurized sorbent was then regenerated and reduced in the same manner as in Cycle B. CCG was then desulfurized in the same manner as Cycle B. Effluent Samples were taken at hourly increments and designated 1C-4C (Cycle C).

Samples from Cycles A-C were analyzed for sulfur content using x-ray fluorescence. The results are summarized in Table 3.

TABLE 3
Desulfurization of CCG (345 ppmw Sulfur) with Sorbent D

| | Cycle A | Cycle B | Cycle C |
|---|---|---|---|
| Sample | (ppmw Sulfur) | (ppmw Sulfur) | (ppmw Sulfur) |
| 1 | <5 | <5 | 10 |
| 2 | <5 | 5 | 15 |
| 3 | 15 | 5 | 45 |
| 4 | 15 | 20 | 110 |

A 10 gram quantity of −100/+325 mesh Sorbent E was placed in the reactor. CCG was desulfurized in the same manner as described with respect to Sorbents C and D. Effluent samples were taken hourly and designated Samples 1A-4A (Cycle A).

The sulfurized sorbent was then regenerated in the same manner as Sorbents C and D except the nitrogen flow rate was 180 cc/min and the air flow rate was 120 cc/min. The regenerated sorbent was reduced in the same manner as Sorbents C and D.

Cycles B, C, D, and E were carried out in substantially the same manner as Cycle A, with regeneration and oxidation between each cycle being accomplished in the same manner as described above for regeneration and reduction between Cycle A and Cycle B.

Samples from Cycle A-E were analyzed for sulfur content using x-ray fluorescence. The results are summarized in Table 4.

TABLE 4
Desulfurization of CCG (345 ppmw Sulfur) with Sorbent E

| | Cycle A | Cycle B | Cycle C | Cycle D | Cycle E |
|---|---|---|---|---|---|
| | (ppmw | (ppmw | (ppmw | (ppmw | (ppmw |
| Sample | Sulfur) | Sulfur) | Sulfur) | Sulfur) | Sulfur) |
| 1 | 10 | <5 | 5 | 20 | 5 |
| 2 | 20 | <5 | 10 | 25 | 15 |
| 3 | 20 | 5 | 10 | 45 | 95 |
| 4 | 30 | 10 | — | 110 | 185 |

Tables 2-4 demonstrate that a sorbent whose attrition resistance has been enhanced with sodium silicate is effective to remove sulfur from cracked-gasoline.

Reasonably variations, modifications, and adaptations can be made within the scope of this disclosure and the appended claims without departing from the scope of this invention.

What is claimed is:

1. A sorbent composition suitable for removing sulfur from a hydrocarbon-containing fluid, said sorbent composition comprising:
a support;
a promoter; and
a silicate.

2. A sorbent composition according to claim 1 wherein said support comprises zinc oxide.

3. A sorbent composition according to claim 2 wherein said promoter comprises a metal selected from the group consisting of nickel, cobalt, iron, manganese, copper, zinc, molybdenum, tungsten, silver, tin, vanadium, antimony, and combinations thereof.

4. A sorbent composition according to claim 3 wherein said silicate includes a metal component selected from the group consisting of sodium, potassium, zirconium, aluminum, barium, beryllium, calcium, iron, magnesium, manganese, and combinations thereof.

5. A sorbent composition according to claim 4 wherein said promoter comprises a reduced-valence promoter.

6. A sorbent composition according to claim 1 wherein said support comprises zinc oxide, silica and alumina.

7. A sorbent composition according to claim 6 wherein said promoter comprises reduced-valence nickel.

8. A sorbent composition according to claim 7 wherein said silicate is sodium silicate.

9. A sorbent composition according to claim 8 wherein said sorbent composition comprises said zinc oxide in an amount in a range of from about 10 to about 90 weight percent, said silica in an amount in the range of from about 5 to about 85 weight percent, said alumina in an amount in the range of from about 1 to about 30 weight percent, said reduced-valence nickel in an amount in the range of from about 0.5 to about 50 weight percent, and said sodium silicate in an amount in the range of from about 1 to about 40 weight percent.

10. A sorbent composition according to claim 9 wherein said reduced-valence nickel has a valence of less than 2.

11. A sorbent composition as claimed in claim 1 wherein said promoter comprises at least 10 weight percent reduced-valence nickel, said reduced-valence nickel having a valence of zero.

12. A sorbent composition according to claim 1 wherein said sorbent composition comprises a microsphere having a mean particle size in the range of from about 1 micrometer to about 500 micrometers.

13. A sorbent composition according to claim 1 wherein said sorbent composition has a Davison Index value of less than 20 percent.

14. A process of making a sorbent composition comprising:
(a) admixing a first support component and a second support component to form a support mix;
(b) particulating said support mix to thereby provide a support particulate;
(c) contacting said support particulate with a promoter to thereby provide a promoted particulate comprising an unreduced promoter;
(d) reducing said promoted particulate to thereby provide a reduced particulate comprising a reduced-valence promoter; and
(e) incorporating a silicate with a silicate-enhanced component selected from a group consisting of said support mix, said support particulate, said promoted particulate, and combinations thereof.

15. A process according to claim 14 wherein said silicate includes a metal component selected from the group consisting of sodium, potassium, zirconium, aluminum, barium, beryllium, calcium, iron, magnesium, manganese, and combinations thereof.

16. A process according to claim 15 wherein said promoter is selected from the group consisting of metals, metal oxides, and combinations thereof.

17. A process according to claim 16 wherein said first support component comprises zinc oxide.

18. A process according to claim 17 wherein said reduced-valence promoter has a valence which is less than the valence of said unreduced promoter.

19. A process according to claim 18 wherein said silicate-enhanced component is said support mix.

20. A process according to claim 19 wherein said silicate is incorporated with said support mix by physically mixing said silicate and said support mix.

21. A process according to claim 18 wherein said silicate-enhanced component is said support particulate.

22. A process according to claim 21 wherein said silicate is incorporated with said support particulate by impregnating said support particulate with said silicate.

23. A process according to claim 18 wherein said silicate-enhanced component is said promoted particulate.

24. A process according to claim 23 wherein said silicate is incorporated with said promoted particulate by impregnating said promoted particulate with said silicate.

25. A process according to claim 14 wherein said silicate comprises sodium silicate.

26. A process according to claim 25 wherein said promoter comprises nickel.

27. A process according to claim 26 wherein said support mix comprises zinc oxide, silica, and alumina.

28. A process according to claim 27 wherein said reduced-valence promoter comprises reduced-valence nickel.

29. A process according to claim 28 wherein said reduced-valence nickel has a valence of less than 2.

30. A process according to claim 29 wherein said support mix is in the form of a slurry, wherein said slurry is particulated by spray-drying, wherein said support particulate is in the form of a microsphere having a mean particle size in the range of from about 1 micrometer to about 500 micrometers.

31. A process as claimed in claim 29 wherein said silicate-enhanced component is said support mix.

32. A process according to claim 31 wherein said silicate is incorporated with said support mix by physically mixing said silicate and said support mix.

33. A process according to claim 29 wherein said silicate-enhanced component is said support particulate.

34. A process according to claim 33 wherein said silicate is incorporated with said support particulate by impregnating said support particulate with said silicate.

35. A process according to claim 29 wherein said silicate-enhanced component is said promoted particulate.

36. A process according to claim 35 wherein said silicate is incorporated with said promoted particulate by impregnating said promoted particulate with said silicate.

37. A process according to claim 14 wherein said sorbent composition comprises zinc oxide in an amount in the range of from about 10 to about 90 weight percent, silica in an amount in the range of from about 5 to about 85 weight percent, alumina in an amount in the range of from about 1 to about 30 weight percent, reduced-valence nickel in an amount in the range of from about 0.5 to about 50 weight percent, and sodium silicate in an amount in the range of from about 1 to about 40 weight percent.

38. A process according to claim 37 wherein said reduced-valence nickel has a valence of zero.

39. A process according to claim 38 wherein said support particulate is dried and calcined prior to contacting with said promoter, and wherein said promoted particulate is dried and calcined prior to reduction.

40. A process according to claim 39 wherein said silicate-enhanced component is said support mix.

41. A process according to claim 40 wherein said silicate is incorporated with said support mix by physically mixing said sodium silicate, said zinc oxide, said silica, and said alumina.

42. A process according to claim 39 wherein said silicate-enhanced component is said support particulate.

43. A process according to claim 42 wherein said silicate is incorporated with said support particulate by spray-impregnating said support particulate with said sodium silicate.

44. A process according to claim 39 wherein said silicate-enhanced component is said promoted particulate.

45. A process according to claim 44 wherein said silicate is incorporated with said promoted particulate by spray-impregnating said promoted particulate with said sodium silicate.

46. The product produced by the process of claim 14.

47. The product produced by the process of claim 39.

48. A process for removing sulfur from a hydrocarbon-containing fluid stream, said process comprising the steps of:
(a) contacting said hydrocarbon-containing fluid stream with a sorbent composition comprising a support, a promoter, and a silicate in a desulfurization zone under conditions such that there is formed a desulfurized fluid stream and a sulfurized sorbent;
(b) separating said desulfurized fluid stream from said sulfurized sorbent;
(c) regenerating at least a portion of the separated sulfurized sorbent in a regeneration zone so as to remove at least a portion of the sulfur therefrom and provide a desulfurized sorbent;
(d) reducing said desulfurized sorbent in an activation zone to provide a reduced sorbent composition which will affect the removal of sulfur from said hydrocarbon-containing fluid stream when contacted with the same; and
(e) returning at least a portion of said reduced sorbent composition to said desulfurization zone.

49. A process in accordance with claim 48 wherein said support comprises zinc oxide, silica, and alumina.

50. A process in accordance with claim 49 wherein said promoter comprises nickel.

51. A process in accordance with claim 50 wherein said silicate comprises sodium silicate.

52. A process in accordance with claim 48 wherein said contacting is carried out at a temperature in the range of from about 100° F. to about 1000° F. and a pressure in the range of from about 15 to about 1500 psia.

53. A process in accordance with claim 48 wherein said regeneration is carried out at a temperature in the range of from about 100° F. to about 1500° F. and a pressure in the range of from about 25 to about 500 psia.

54. A process in accordance with claim 53 wherein there is employed air as a regeneration agent in said regeneration zone.

55. A process in accordance with claim 48 wherein said desulfurized sorbent is subjected to reduction with hydrogen in said activation zone which is maintained at a temperature in the range of from about 100° F. to about 1500° F. and a pressure in the range of from about 15 to about 1500 psia during reduction.

56. A process in accordance with claim 48 wherein the separated sulfurized sorbent is stripped prior to introduction into said regeneration zone.

57. A process according to claim 48 wherein said desulfurized sorbent is stripped prior to introduction into said activation zone.

58. A process in accordance with claim 48 wherein said promoter comprises reduced-valence nickel having a valence of less than 2.

59. A process in accordance with claim 48 wherein said promoter comprises reduced-valence nickel having a valence of zero.

60. A process in accordance with claim 48 wherein said hydrocarbon-containing fluid stream is cracked-gasoline.

61. A process in accordance with claim 48 wherein said hydrocarbon-containing fluid stream is diesel.

62. The product produced by the process of claim 60.

63. The product produced by the process of claim 61.
